(19) United States
(12) Patent Application Publication
(10) Pub. No.: US 2020/0376902 A1
(43) Pub. Date: Dec. 3, 2020

(54) Tire identification system and method

(71) Applicant: IDENTIFICATION TIRE-TAG, BROSSARD (CA)

(72) Inventor: BRUNO MORIN, BROSSARD (CA)

(21) Appl. No.: 16/903,122

(22) Filed: Jun. 16, 2020

Related U.S. Application Data
(60) Provisional application No. 62/921,136, filed on Jun. 3, 2019.

(51) Int. Cl. B60C 13/00; B60C 19/00

(52) U.S. Cl. CPC B60C 13/001; B60C 19/00

(57) ABSTRACT

The present invention aims at solving tire storing information problems by providing a method and system for identifying sets of tires. the system of identification comprises a band made of resilient yet flexible material comprising identification information related to a tire, such as the owner's or a garage contact information, the installation localization of the tire and so on. The band may be secured to a tire, with or without rim, by an attachment mechanism, such as hook and loops or quick release clips. The information may be affixed to the band by sewing another piece of fabric material, installing a paper into a plastic cover or by pinning a pin. The information may be in the form of text, images, colors or code bars. The invention is not limited to warehouses, as it may further be used in home storage and garages.

### CROSS-REFERENCE TO RELATED APPLICATIONS

The present patent application claims the benefits of priority of the U.S. Provisional Patent Application No. 62/921,136, entitled “Tire identification solution for warehousing” and filed at the United States Patent and Trademark Office on Jun. 3, 2019, the content of which is incorporated herein by reference.

### FIELD OF THE INVENTION

The present invention generally relates to systems and method to identify tires or wheels. More particularly, the present invention generally relates to tags, labels or bands to identify tires and wheels.

### BACKGROUND OF THE INVENTION

In countries where the temperature gets substantially cold during winter, vehicle tires need to be swapped to improve driveability on icy and snowy roads. Generally, winter tires are not optimal when driven in hot temperatures and summer tires are not optimal when driven on icy or snowy roads. In some countries or states, car owners are prescribed by law to swap summer for winter tires and vice-versa. In some cases, the tires are swapped by removing them from the wheel rims. In other cases, the rims comprising the tires are swapped for additional rims comprising the tires for another weather condition.

Unused tires or wheels with tires are typically stored, such as being stored in car dealerships, vehicle parts shops, garages in the home of the vehicle owner. Since many tires or wheels may look alike, tires or wheels may be identified. Typically, one will use a sticker and/or chalk to identify a set of tires. The main disadvantage of such identification method is that the sticker may get withdrawn or the chalk may be erased, such as when manipulating the tires. When the identification information is lost, time and financial resources may be spent by the entity storing the tires or by the owner himself.

Another identifying technique may be the use of electronic tags, which may be applied on tires and later read or scanned for access to the information. Such technique, while increasing reliability, is costly and may require training of staff.

Given the drawbacks of the conventional stored tires identification techniques, there is a need for an identification system that is simple, practical and cost effective for both large surface warehouses and owners storing tires at home.

### SUMMARY OF THE INVENTION

The aforesaid and other objectives of the present invention are realized by generally providing a tire identification band comprising information related to a tire.

In an aspect of the invention, an identification band for a set of tires is provided. The band comprises a main body made of resilient and flexible material, the main body comprising two opposed surfaces and two ends, an attachment system adapted to form a loop around a portion of one of the tires of the set by attaching the two ends of the main body and identification information of the set of tires displayed on at least one the two surfaces. The attachment system is located at both ends of the main body and the identification information is affixed to the main body.

The length of the main body may be longer than the width of the body. The resilient material may be stretchable fabric to form the loop around the tire.

The attachment system may comprise a first attachment member and a second attachment member adapted to mate with one another. The first attachment member may be attached at a first of the two ends of the band and the second attachment member may be attached at the other of the two ends of the band. The first attachment member may be a hook and the second attachment member being a loop.

The attachment system may be adapted to form a plurality of sizes of the loop around the tire. The identification information may be displayed on a piece of resilient material attached to one of the surfaces of the main body of the band. The identification information may further comprise an identification code. The identification information may comprise one color code associated with a predetermined set of tires.

The tires may be unmounted to a rim, the band forming a loop around an external portion of one of the tires and around edges of an inner aperture of the one of the tires.

The tires may be being mounted to a rim, the band forming a loop around an external portion of one of the tires, through an aperture of the rim and over an inner portion of the rim. The aperture of the rim may be formed by at least two spokes of the rim.

In another aspect of the invention, a method for identifying a set of unmounted tires is provided. The method comprises for each of the tires, passing a resilient and flexible identification band around an external portion of the tire and around edges of an inner aperture of the tire, all of the resilient and flexible identification bands having a common identification code and for each of the tires, forming a closed loop by connecting a first attachment member at one end of the band to a second attachment member at a second end of the band.

The method may further comprise stretching the identification band to connect the first and second attachment members. The common identification code may be a color.

In yet another aspect of the invention, a method for identifying a set of tires mounted to rims is provided. The method comprises for each of the tires, passing a resilient and flexible identification band around an external portion of the tire, over an inner portion of the rim and within an aperture of the rim, all of the resilient and flexible identification bands having a common identification code and for each of the tires, forming a closed loop by connecting a first attachment member at one end of the band to a second attachment member at a second end of the band.

The method may further comprise stretching the identification band to connect the first and second attachment members.

Passing the resilient and flexible identification band through the aperture may further comprise passing through the aperture formed by at least two spokes of the rim.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a front perspective view of an embodiment of a tire identification band in accordance with the principles of the present invention shown attached on a tire mounted to a rim.

FIG. 2 is a rear perspective view of the tire identification band of FIG. 1.

FIG. 3 is a front elevation view of the tire identification band of FIG. 1.

FIG. 4 is a rear elevation view of the tire identification band of FIG. 1.

FIG. 5 is a left elevation view of the tire identification band of FIG. 1.

FIG. 6 is a right elevation view of the tire identification band of FIG. 1.

FIG. 7 is a top plan view of the tire identification band installed of FIG. 1.

FIG. 8 is a bottom plan view of the tire identification band installed of FIG. 1.

FIG. 9 is a front perspective view of an embodiment of a tire identification band.

FIG. 10 is a rear perspective view of the tire identification band of FIG. 9.

FIG. 11 is a front elevation view of the tire identification band installed of FIG. 9.

FIG. 12 is a rear elevation view of the tire identification band of FIG. 9.

FIG. 13 is a left elevation view of the tire identification band of FIG. 9.

FIG. 14 is a right elevation view of the tire identification band of FIG. 9.

FIG. 15 is a top plan view of the tire identification band of FIG. 9.

FIG. 16 is a bottom plan view of the tire identification band of FIG. 9.

FIG. 17 is an illustration of an embodiment of a tire identification band in accordance with the principles of the present invention shown with identifying information; and

FIG. 18 is an illustration of another embodiment of a tire identification band in accordance with the principles of the present invention shown with identifying information.

FIG. 19 is an illustration of yet another embodiment of a tire identification band in accordance with the principles of the present invention shown with identifying information.

FIG. 20 is an illustration of further embodiments of tire identification bands in accordance with the principles of the present invention shown with identifying information.

### DETAILED DESCRIPTION OF THE PREFERRED EMBODIMENT

A novel tire identification system and method will be described hereinafter. Although the invention is described in terms of specific illustrative embodiment(s), it is to be understood that the embodiment(s) described herein are by way of example only and that the scope of the invention is not intended to be limited thereby.

The present invention generally relates to a tire identification band 10, also referred to as band. The band 10 is generally made of flexible material, such as fabric or elastic fabric. The band 10 is longitudinally extending to at least encircle or wrap a sectional area of a tire or a tire mounted on a rim. Understandably, the proportions of the present disclosure are not limited to one embodiment as there may be multiple embodiments with different length, thickness and width. For example, a band 10 may be longitudinally extending to allow circling a section of any type of tire or wheel and may further be adapted to circle around the entire wheel or tire if needed. The band material may further be stretchable in order to allow a single band to adapt to a large range of tire sizes.

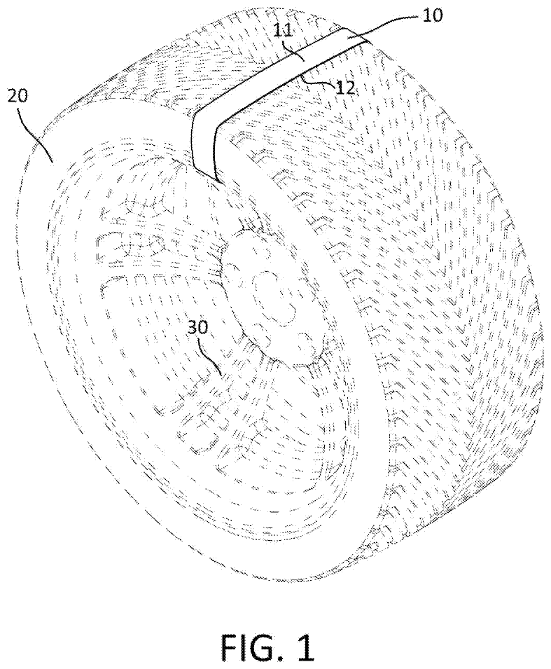

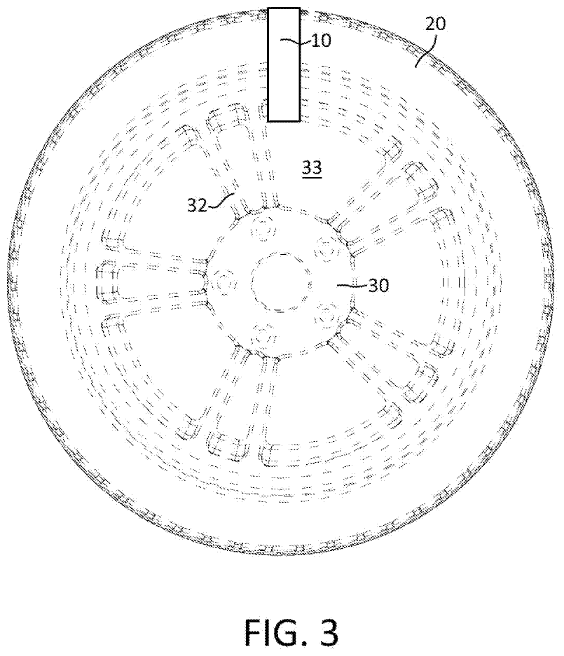

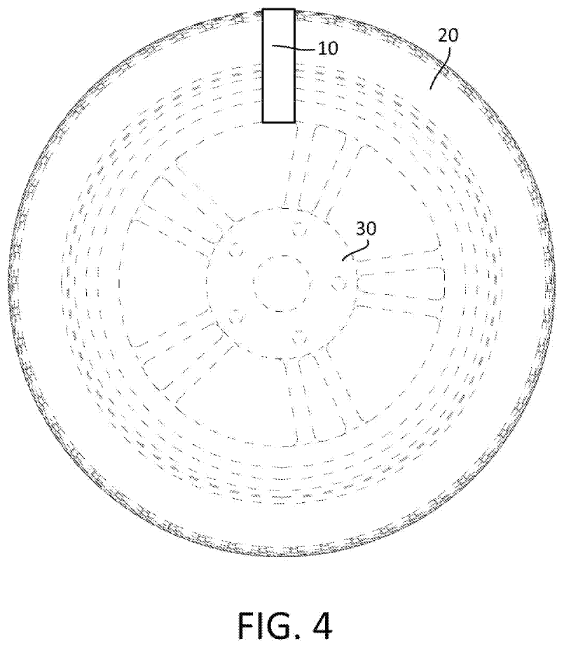

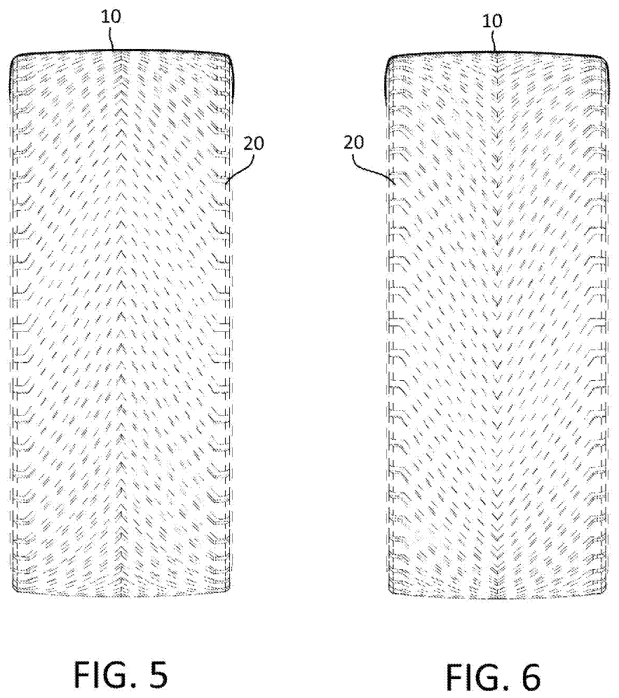

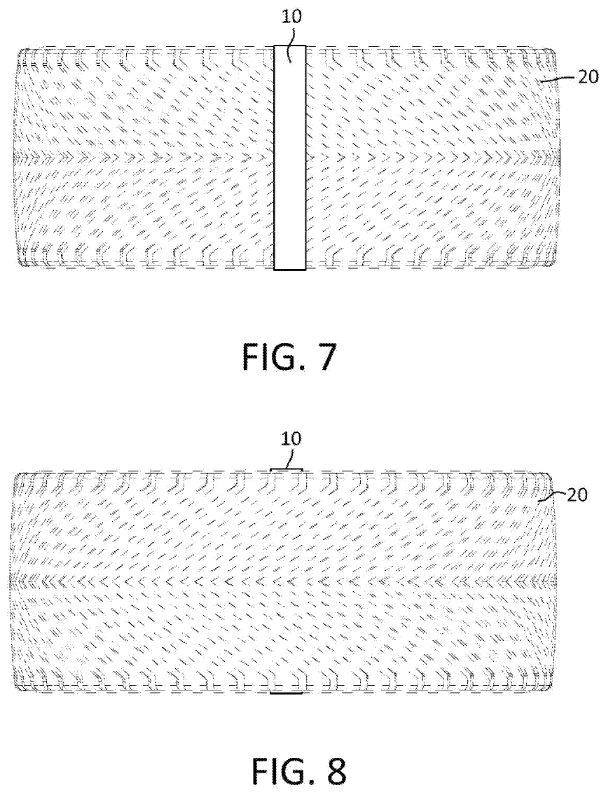

Referring now to FIGS. 1 to 8, an embodiment of a system for identifying a tire 20 mounted to a rim 30 is illustrated. The band 10 generally comprises two sides 11, 12 and is longitudinally shaped. The band 10 further comprises a first 13 and a second 14 extremity. In the embodiment of FIGS. 1 to 8, the band is generally shaped as an elongated rectangle. The band 10 further comprises an attachment system 15 adapted to form a loop with the band 10. The attachment system generally 15 comprises a first attachment member 150 and a second attachment member 152 adapted to mate with one another.

As discussed above, the band 15 forms a loop using a securing or attachment system 15. The attachment system 15 may use any attachment mechanism known in the art allowing a loop to be formed with the band 10.

In a typical embodiment, the attachment system 15 may be embodied as a hook and loop fastener, where one of the attachment members 150 is the hook and the other attachment member 152 is a loop. In such embodiment, the hook portion 150 or the loop portion 152 may be longitudinal extended along at least a part of the length of the band 10 to allow forming a loop with the band 10 having different radiuses, such as to adapt to a plurality of types of tires 20, which typically have different sizes. In another embodiment, the first attachment member 150 is attached to the first extremity 13 on a first side 11 and the second attachment member 152 is attached at the second extremity 14 on the second side 12. In such an embodiment, the loop is formed by aligning both extremities 13, 14 and overlapping the first surface 11 and the second surface 12 of the band 10. In yet another embodiment, the attachment system 15 may be a quick release clip installed at each of the extremities 13, 14 of the band 10.

Understandably, any other types of attachment systems 15 may be used within the scope of the present invention, such as but not limited to clips, buttons, straps, ratchet, etc. In some embodiments, the first attachment member 150 is located at a first extremity 13 and the second attachment member 152 is located a second extremity 14.

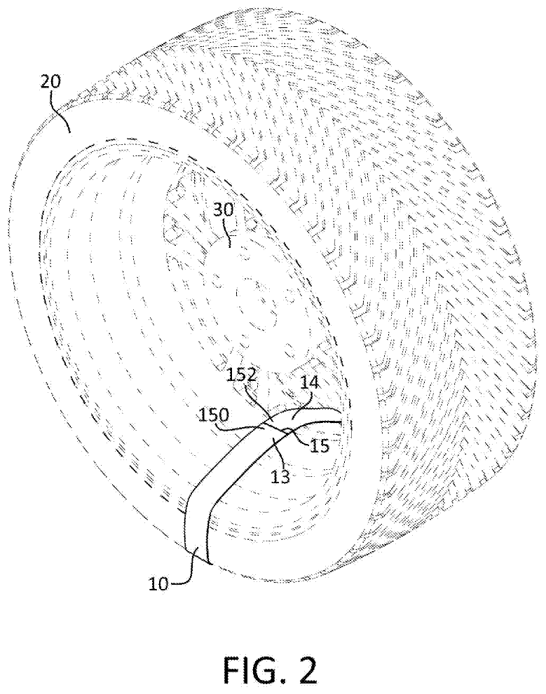

Referring now to FIG. 2, the band 10 is slightly radially stretched to conform to the inner portion 32 of the rim 30. As shown in FIG. 2, the rim 20 typically comprises a plurality of spokes 33. The band 10 may conform to the inner portion 32 of the rim 30, pass through an aperture formed by at least two spokes 33 and circled around the tire 20 mounted of the rim 30 to form a loop using the attachment system 15. In some embodiment, the first attachment member 150 is mating with the second attachment member 152 to form the loop.

One skilled in the art shall understand that the band 10 may be attached to the tire 20 or rim 30 in a plurality of manners.

In one embodiment, the band 10 is circled or wrapped around a section of the unmounted rim. In such an embodiment, the band 10 may be pressed on the inner portion 32 of the rim 30, passed through an aperture formed by at least two spokes 33 and circled around the outer portion (not shown) of the rim to form a loop using the attachment system 15. In some embodiment, the first attachment member 150 is mating with the second attachment member 152 to form the loop.

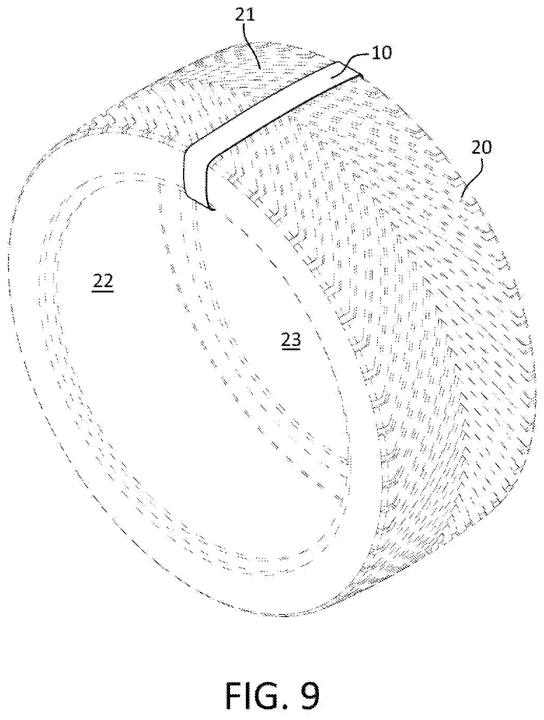

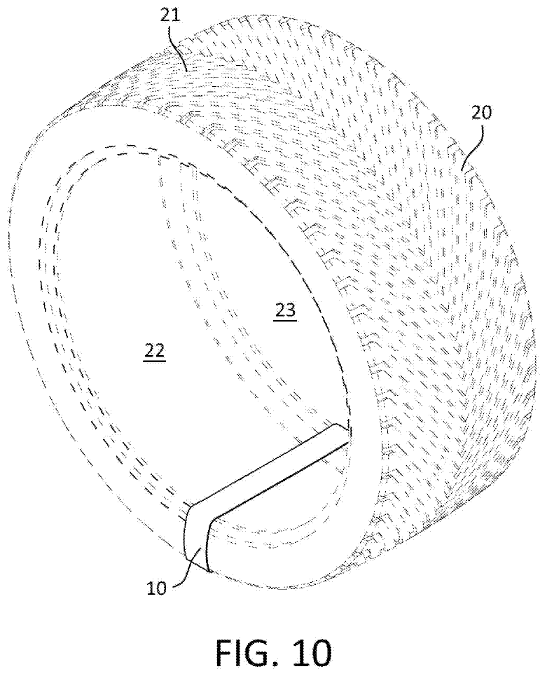

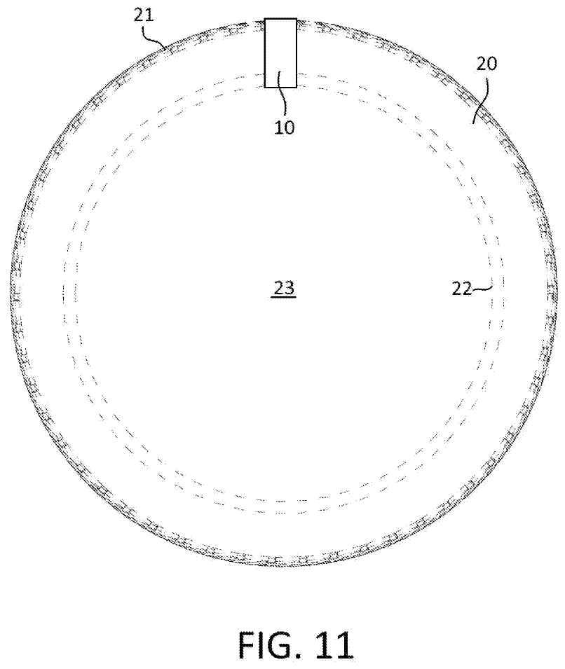

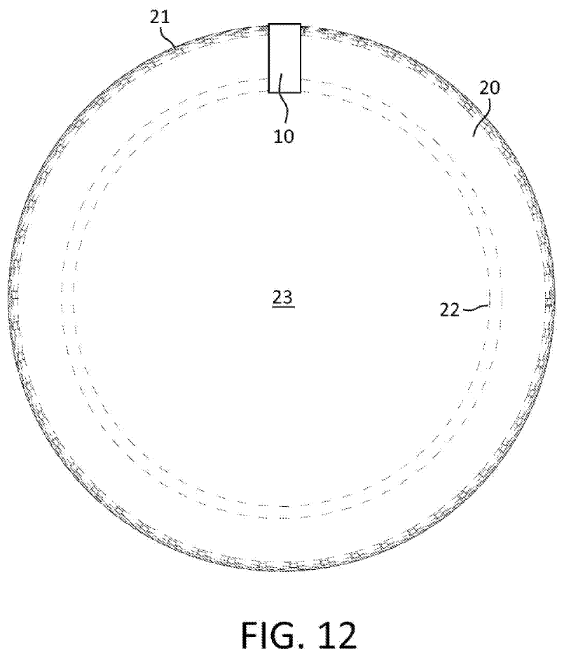

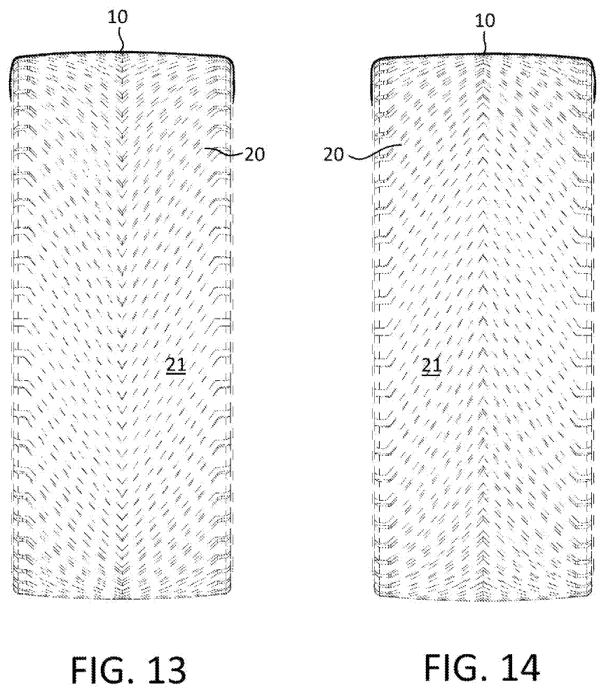

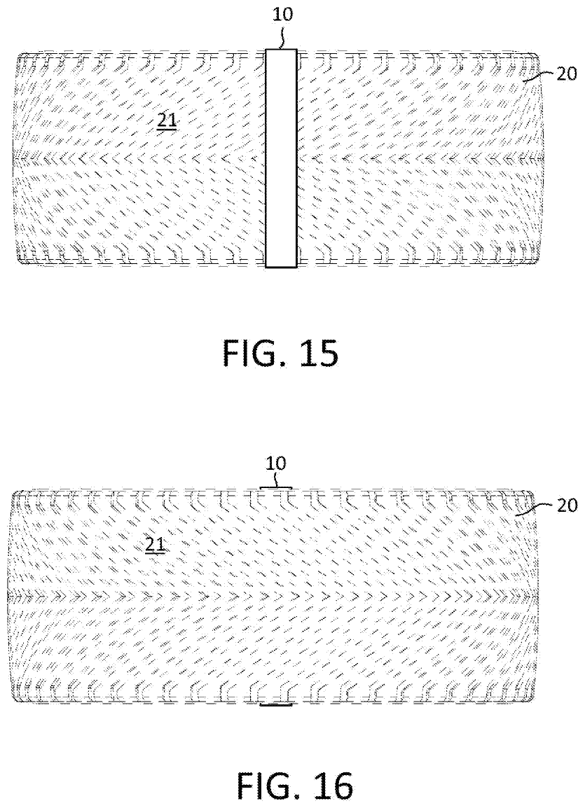

Referring now to FIGS. 9 to 16, another embodiment is illustrated using the band 10 on an unmounted tire 20. In such an embodiment, the band 10 may be pressed on the inner edges 22 of the tire 20, passed through the inner aperture 23 of the tire and circled around the outer portion 21 of the tire 20 to form a loop using the attachment system 15. In some embodiment, the first attachment member 150 is mating with the second attachment member 152 to form the loop.

As described above, in some embodiments, the length of the band 10 may be different in different uses (i.e. wrapped around a tire mounted on a rim, an unmounted tire and/or a rim without a tire). One may appreciate that the band 10 may be wrapped or form a loop around any portion of a tire or a rim, as long as the attachment system 15 is properly secured.

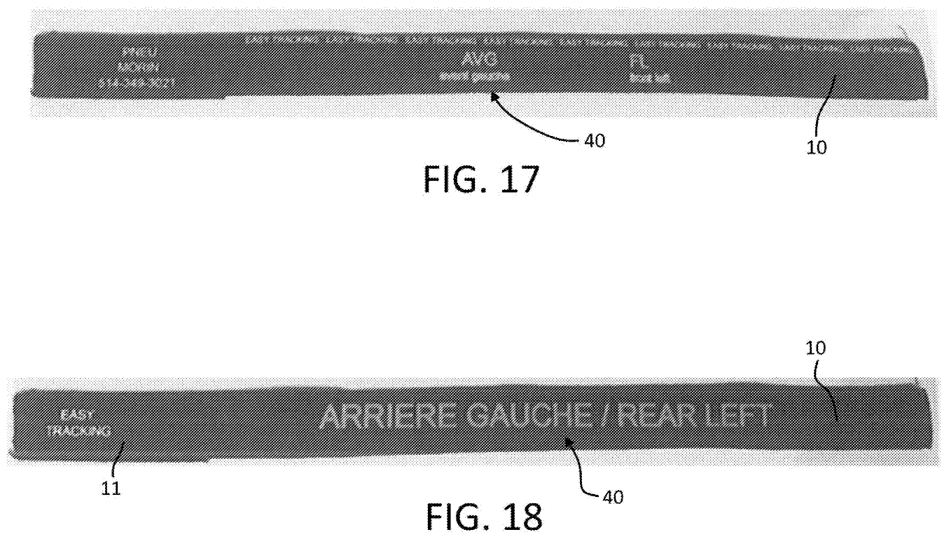

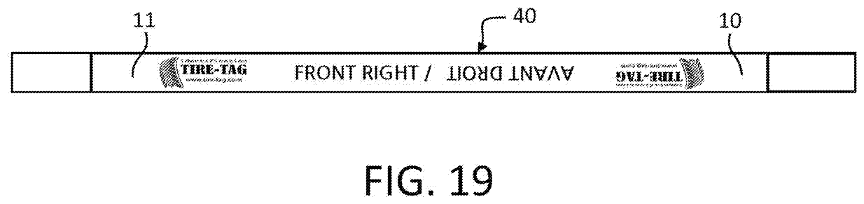

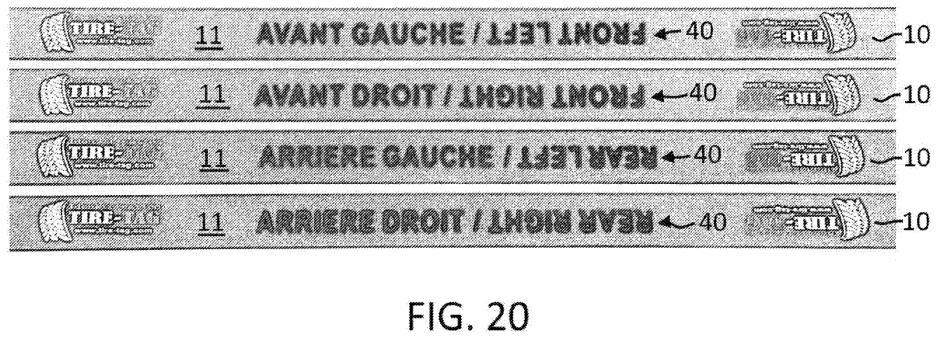

Referring now to FIGS. 17 to 20, embodiments of a band 10 comprising identification information 40 is shown. The identification information 40 may be affixed, printed, sewn and/or glued to the band 10 in any way known in the art. In other embodiments, the identification information 40 may be printed on a piece of fabric which is affixed to the band 10, such as but not limited sewed or glued to the band 10. In a further embodiment, the identification information 40 may be printed or stamped to a plastic surface which is affixed, glued or sewn to the band 10. In yet other surface, the band 10 may comprise a pocket having a transparent area (not shown), the identification information being printed or stamped on a semi-rigid or flexible material and being inserted in the pocket. In yet another embodiment, the band 10 may comprise pins with identification information 40, the said pins may be sewn, glued or pinned to the band 10.

In some embodiment, the identification information 40 is coded with colors, each color referring to a different set of tires 20 or wheels 30. As an example, a first set of tires 20 may have each of the tires 20 wrapped with a band having a first color (i.e. red) and a second set of tires 20 may have each of the tires 20 wrapped with a band having a second color (i.e. green). A user may then identify each of the tires 20 of a set by finding all band 10 having the same desired color. Understandably, any other known method to code the set of tires 20 may be used without departing from the concept of the present invention, such as bands having images (i.e. logo of car manufacturer), text (i.e. car model, year, etc.), combination of images and text or any other coding method known in the art, such as 2D code bar or hash.

Obviously, any type of identification information 40 may be affixed to the band 10 as long as such identification information fits fully or partly on the one or two surfaces 11, 12 of the band 10. In some embodiments, the band 10 may further comprise promotional information 42 on the first 11 and/or second 12 surfaces. As an example, the name of service provider, such as the car dealer or mechanic, in charge of changing the tires 20 may be printed or displayed on the band 10. In yet other embodiments, the identification information 40 may comprise the name, telephone number, email address, street address or any other information of the owner or user of the tires 20. The identification information 40 may further comprise information about the vehicle itself, such as identification number, model, model year, recommended pressure level of the identified tire, etc.

In further embodiments, the identification information 40 may comprise the last position of the tire 20 or the position of the tire 20 for next installation on the vehicle, such as in the front or back of the vehicle and on the left or right of the same. For example, the following identifiers may be used to locate a tire: front left (FL), front right (FR), rear left (RL), rear right (RR). Referring to FIG. 17, one may appreciate that the contact information of a tire service provider is displayed on the left of the band and the last localization of the tire 20 is displayed on a central portion. Referring now to FIGS. 18 to 20, the bands 10 comprise a trademark or logo on a side portion of the first surface 11.

As described above, the identification information 40 displayed on the band 10 may comprise an identification code, such as a code bar, hash code, RFID, etc. In such an embodiment, the identification code is located on one of the surfaces 11, 12 or on both surfaces of the band 10. The identification code is scanned or detected using a code reader or RF reader. The read identification code is communicated to a computerized device configured to decode the information or to fetch the information in a database. The resulting information is displayed on the computerized device or communicated to another computerized device through a network. In a typical embodiment, the computerized device is a smart phone configured to scan and read the identification code of the band 10.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) An identification band for a set of tires, the band comprising:
a main body made of resilient and flexible material, the main body comprising two opposed surfaces and two ends;
an attachment system adapted to form a loop around a portion of one of the tires of the set by attaching the two ends of the main body; and
identification information of the set of tires displayed on at least one the two surfaces;
wherein:
the attachment system is located at both ends of the main body;
the identification information is affixed to the main body.

2) The tire identification band of claim 1, the length of the main body being longer than the width of the body.

3) The tire identification band of claim 1, the resilient material being stretchable fabric to form the loop around the tire.

4) The tire identification band of claim 1, the attachment system comprising a first attachment member and a second attachment member adapted to mate with one another.

5) The tire identification band of claim 4, the first attachment member being attached at a first of the two ends of the band and the second attachment member being attached at the other of the two ends of the band.

6) The tire identification band of claim 4, the first attachment member being a hook and the second attachment member being a loop.

7) The tire identification band of claim 1, the attachment system being adapted to form a plurality of sizes of the loop around the tire.

8) The tire identification band of claim 1, the identification information being displayed on a piece of resilient material attached to one of the surfaces of the main body of the band.

9) The tire identification band of claim 1, the identification information comprising an identification code.

10) The tire identification band of claim 1, the identification information comprising one color code associated with a predetermined set of tires.

11) The tire identification band of claim 1, the tires being unmounted to a rim, the band forming a loop around an external portion of one of the tires and around edges of an inner aperture of the one of the tires.

12) The tire identification band of claim 1, the tires being mounted to a rim, the band forming a loop around an external portion of one of the tires, through an aperture of the rim and over an inner portion of the rim.

13) The tire identification band of claim 12, the aperture of the rim being formed by at least two spokes of the rim.

14) A method for identifying a set of unmounted tires, the method comprising:
for each of the tires, passing a resilient and flexible identification band around an external portion of the tire and around edges of an inner aperture of the tire, all of the resilient and flexible identification bands having a common identification code;
for each of the tires, forming a closed loop by connecting a first attachment member at one end of the band to a second attachment member at a second end of the band.

15) The method of claim 14, the method comprising stretching the identification band to connect the first and second attachment members.

16) The method of claim 14, the common identification code being a color.

17) A method for identifying a set of tires mounted to rims, the method comprising:
for each of the tires, passing a resilient and flexible identification band around an external portion of the tire, over an inner portion of the rim and within an aperture of the rim, all of the resilient and flexible identification bands having a common identification code;
for each of the tires, forming a closed loop by connecting a first attachment member at one end of the band to a second attachment member at a second end of the band.

18) The method of claim 17, the method comprising stretching the identification band to connect the first and second attachment members.

19) The method of claim 17, passing the resilient and flexible identification band through the aperture further comprising passing through the aperture formed by at least two spokes of the rim.
